(19) United States
(12) Patent Application Publication
(10) Pub. No.: US 2017/0362868 A1
(43) Pub. Date: Dec. 21, 2017

(54) Releasable Hinge

(71) Applicant: Jenvan Innovations, Inc., Concord (CA)

(72) Inventors: John Veloso, Concord (CA); Matthew Veloso, Concord (CA)

(21) Appl. No.: 15/182,665

(22) Filed: Jun. 15, 2016

(51) Int. Cl. E05D 7/10; E05D 3/02

(52) U.S. Cl. CPC E05D 7/1005; E05D 3/02; E05D 2007/1027

(57) ABSTRACT

A releasable hinge system having a first component having a circular hinge pin and an arcuate guide fixed thereto. The system further includes a second component having a u-shaped member having an annular groove concentric with and matingly received by the hinge pin. The second component also has an arcuate channel received by the arcuate guide. The method of assembling a hinge includes the steps of providing a first component having a hinge pin and an arcuate guide. The method further includes the step of providing a second component having a u-shaped member having an annular groove concentric with the hinge pin. The second component having an arcuate channel. The method also includes the steps of orienting the first and second components at an angle of 60° relative to each other, causing the u-shaped member to receive the hinge pin, and enabling the second component to rotate within the annular groove about the hinge pin.

### FIELD

The embodiments described herein are directed to a hinge assembly. The hinge assembly design enables quick and easy assembly and disassembly.

### BACKGROUND

In race car driving, there is a need to be able to access, and repair or service a race car quickly. In a car race, when the driver makes a pit stop, the race car must be quickly accessed by the pit crew, quickly serviced and any repairs made, and ready to return to the race track as soon as possible. Thus, there is a need to quickly and effectively access the engine. Hoods today are made with a standard hinge that enables the hood to move upward at an acute angle to the engine during repair. However, hinges on hoods today do not enable the hood to move perpendicular to the engine or beyond, or be easily or quickly removed.

The ability to quickly and easily remove a hood is an advantage in auto racing as it enables a crew to quickly and easily access any area of the engine and once repairs or services are completed, to quickly return the hood to its position over the engine and get the car back on the race track.

Thus, there exists a need for a releasable hinge that enables the hinge components to quickly separate and reassemble as needed.

### SUMMARY

The embodiments described herein are directed to a releasable hinge assembly. The assembly includes a first part having a cylindrical protuberance fixed to a first hinge element and an arcuate guide fixed to the hinge element. The guide is in spaced apart relation to the protuberance and has an arc concentric to the protuberance. The assembly further includes a second part having a second hinge element having a u-shaped member extending outwardly therefrom. The u-shaped member has an inner arcuate surface. The second hinge part further includes an arcuate channel located in spaced apart relation to the inner arcuate surface of the u-shaped member, the inner arcuate surface, channel, and guide being concentric with the protuberance. In use, the first and second parts are easily assembled and disassembled. To assemble, the u-shaped member of the second part receives the protuberance, and the channel receives the guide.

There is also a need for a hinge assembly wherein the u-shaped member rotates about the protuberance.

There is yet a further need for a hinge assembly wherein the first and second hinge elements are perpendicular to one another.

There is still a further need for a hinge assembly wherein the u-shaped member receives the protuberance when the first and second hinge elements are at an angle of 60° relative to each other.

There is further yet a need for a releasable hinge having a first component having a circular hinge pin and an arcuate guide fixed thereto and a second component having a u-shaped member having an annular groove concentric with and matingly received by the hinge pin. The second component also has an arcuate channel received by the arcuate guide.

There is a need for the aforementioned releasable hinge where the u-shaped member is received by the hinge pin when the first and second components are at a 60° angle relative to each other. There is still a need for a releasable hinge where the arcuate channel and arcuate guide are concentric.

There is yet a further need for a method of assembling a hinge having the steps of providing a first component having a hinge pin and an arcuate guide fixed thereto, and providing a second component having a u-shaped member having an annular groove concentric with the hinge pin. The second component has an arcuate channel. The steps also include orienting the first and second components at an angle of 60° relative to each other, causing the u-shaped member to receive the hinge pin, and enabling the second component to rotate within the annular groove about the hinge pin.

There is still a further need for the aforementioned method to include the addition step of enabling the arcuate channel to move relative to the guide.

There is also a need for the aforementioned method wherein the arcuate channel and guide are concentric.

Other objects, features, and advantages of the embodiments described herein will become apparent upon reading the following description when taken in conjunction with the drawings and appended claims.

### BRIEF DESCRIPTION OF THE DRAWINGS

FIG. 1 is a right perspective view of the first part of the first embodiment;

FIG. 2 is a side view of the first part of FIG. 1;

FIG. 3 is a top view of the first part of FIG. 1;

FIG. 4 is a left perspective view of the embodiment of FIG. 1;

FIG. 5 is a right perspective view of the second part of the first embodiment;

FIG. 6 is a left perspective view of the second part of FIG. 5;

FIG. 7 is a top view of the second part of FIG. 5;

FIG. 8 is a right perspective view of the first embodiment prior to assembly;

FIG. 9 is a right perspective view of the embodiment of FIG. 8 being assembled;

FIG. 10 is right exploded perspective view of the embodiment of FIG. 8 during assembly;

FIG. 11 is a right perspective assembled view of the embodiment of FIG. 8;

FIG. 12 is a left perspective view of the embodiment of FIG. 11;

FIG. 13 is a left, rear perspective view of the embodiment of FIG. 8 in its fully installed position;

FIG. 14 is a right, rear perspective view of the embodiment of FIG. 13; FIG. 15 is a side view of the embodiment of FIG. 14;

FIG. 16 is a front exploded view of a second embodiment;

FIG. 17 is a front assembled view of the embodiment of FIG. 16;

FIG. 18 is a perspective view of the second embodiment in its fully installed position;

FIG. 19 is a side view of the embodiment of FIG. 18; and

FIG. 20 is a front view of the embodiment of FIG. 18.

### DETAILED DESCRIPTION

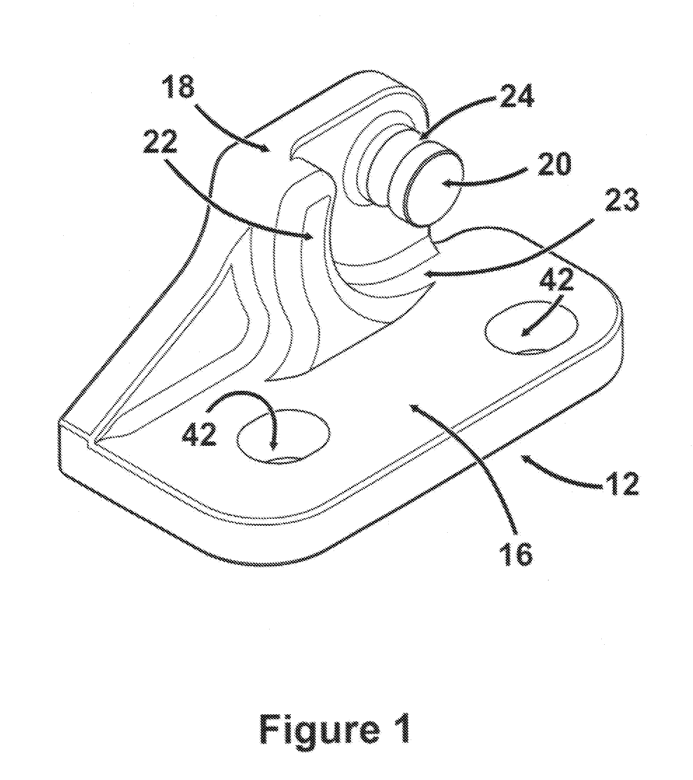

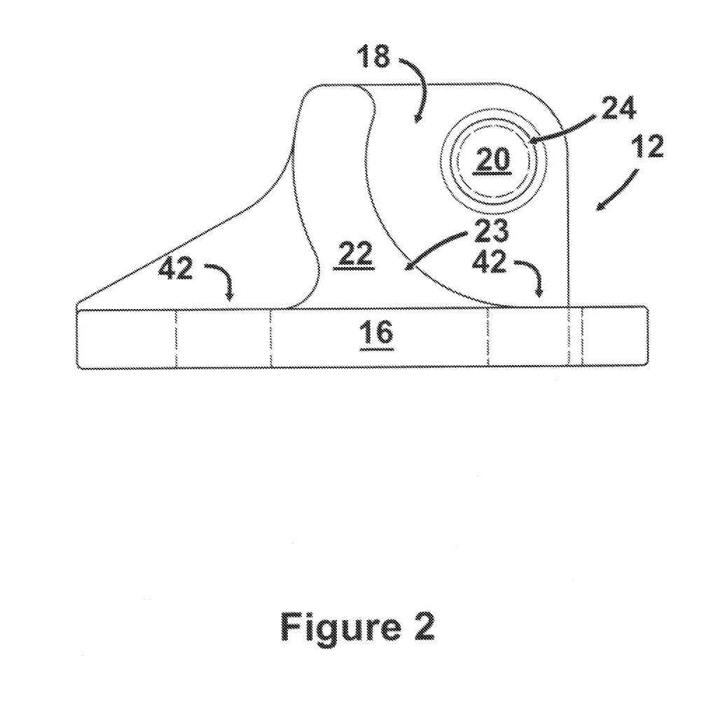

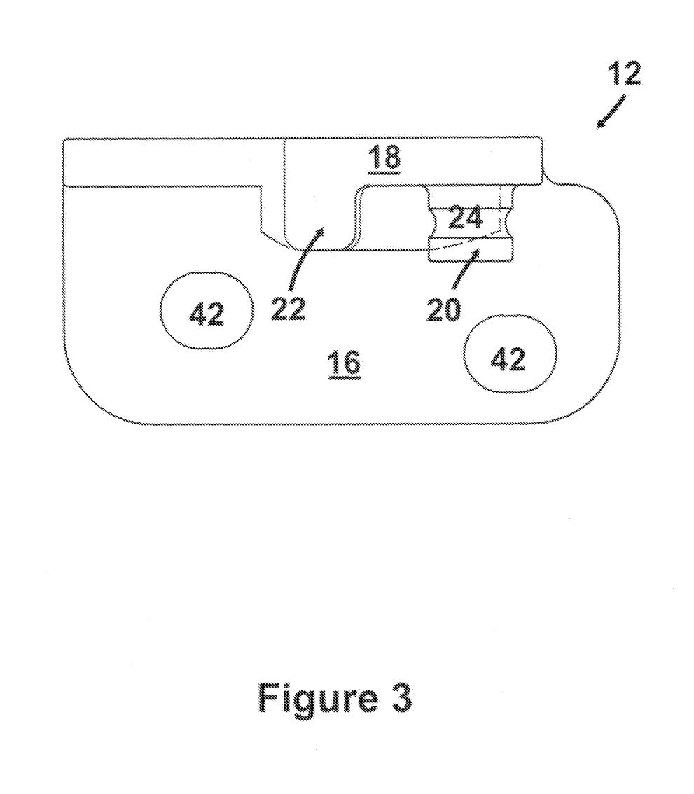

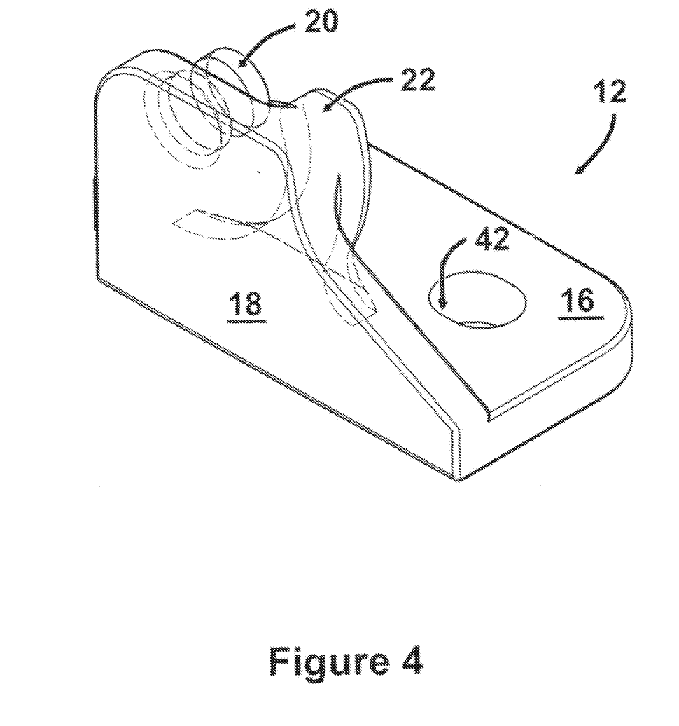

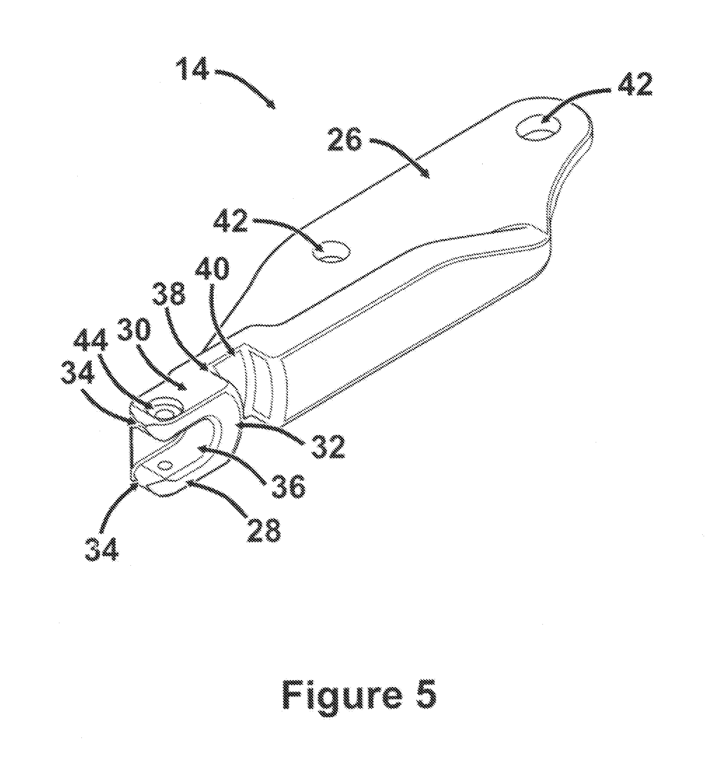

Referring now in more detail to the drawings, in which like numerals refer to like parts throughout the several views, FIG. 1 shows a first embodiment 10 having a first part 12 and a second part 14, shown in FIG. 5. Returning to FIG. 1, the first part 12 includes a first plate 16 fixed perpendicularly to a second plate 18. A cylindrical protuberance 20 is fixed to the second plate 18. An arcuate guide 22 is fixed at the intersection of both the first 12 and second 14 plates.

The arcuate guide 22 has an inner arcuate surface 23. A protuberance circular groove 24 is located along a portion of the axial length of the protuberance 20. The groove 24 forms a circle. The circle is concentric with the inner arcuate surface 23 of the guide 22.

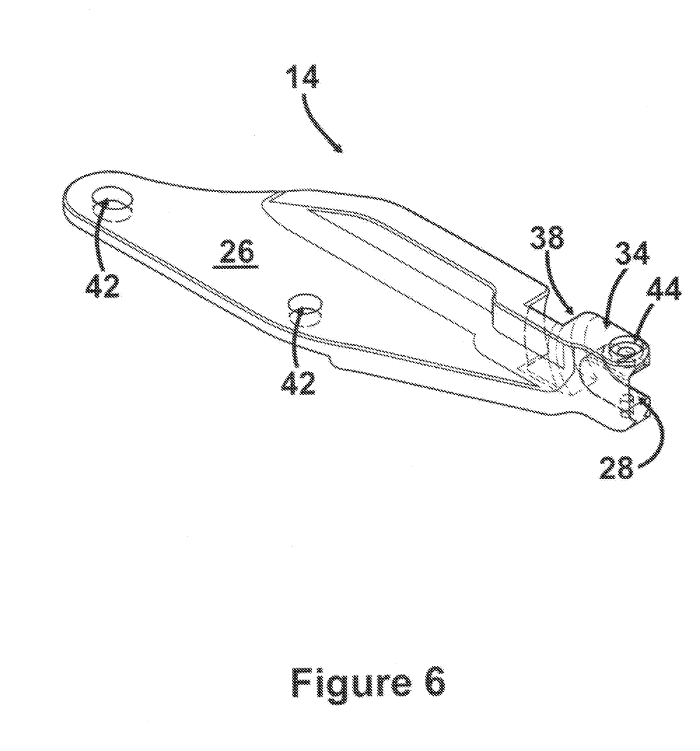

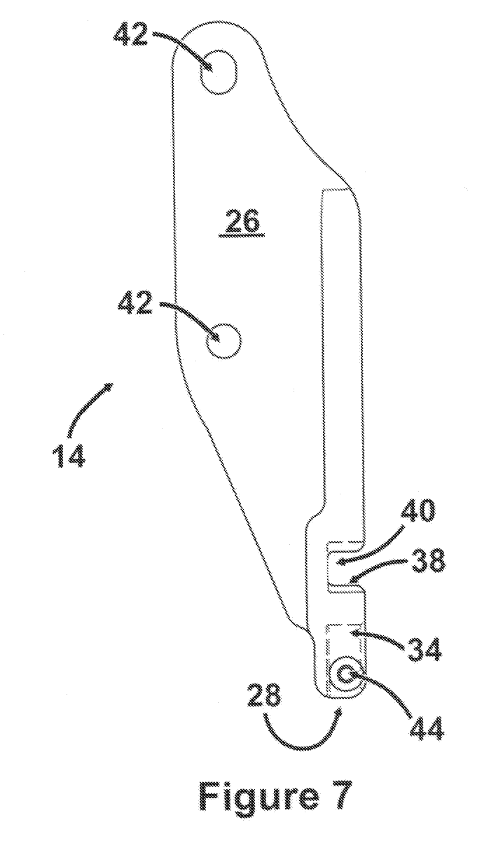

The second part 14, shown in FIG. 5, includes a base 26 having a u-shaped member 28 extending therefrom. The u-shaped member 28 includes includes a u-shaped piece 30 having a rounded portion 32 and a pair of extended arms 34. The u-shaped member 28 has an arcuate inner member surface 36 and an outer member surface 38, shown in more detail in FIG. 6.

The u-shaped member 28 also includes an arcuate recess 40. The rounded portion 32 of the u-shaped member and the arcuate recess 40 are concentric with the inner arcuate surface 23 of the guide 22 and the circular groove 24 of the protuberance 20 of the first part 12.

Bolt holes 42 are located on the first plate 16 and second part 14. The bolt holes 42 receive fastening members (not shown) such as bolts, rivets or the like to fix the first plate 16 and second part 14 to other structures.

For purposes of illustration, the second part 14 of the first embodiment 10 may be fixed by fastening member 44 to a structure such as an automobile body. Similarly, the first plate 16 may be fixed to an automobile hood.

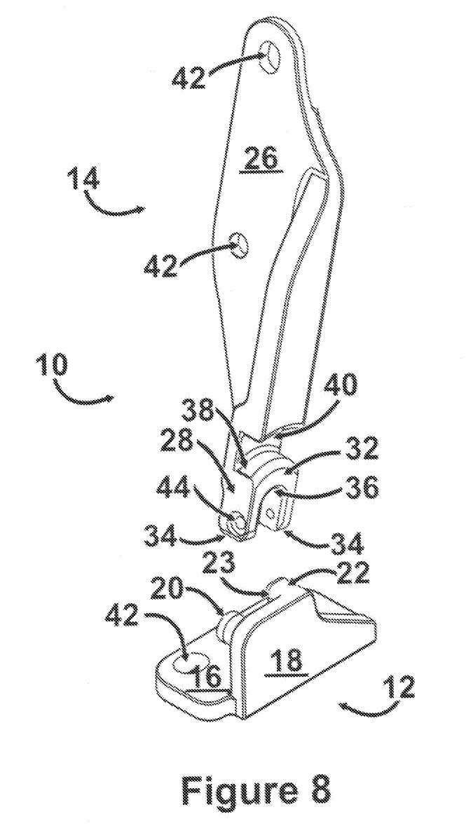

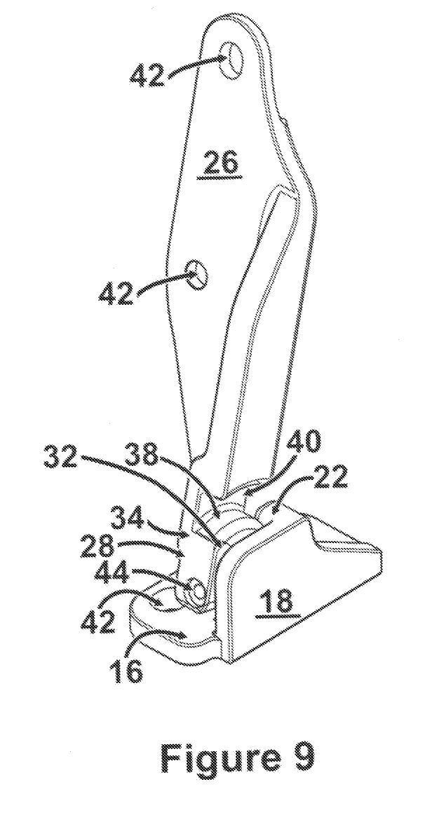

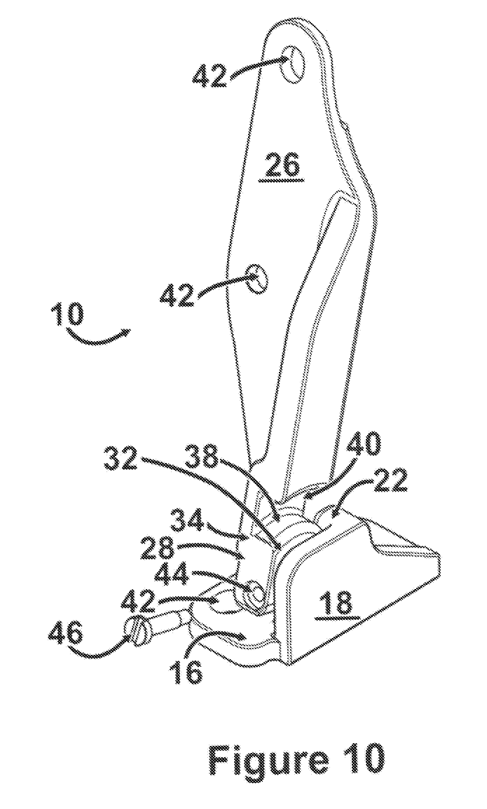

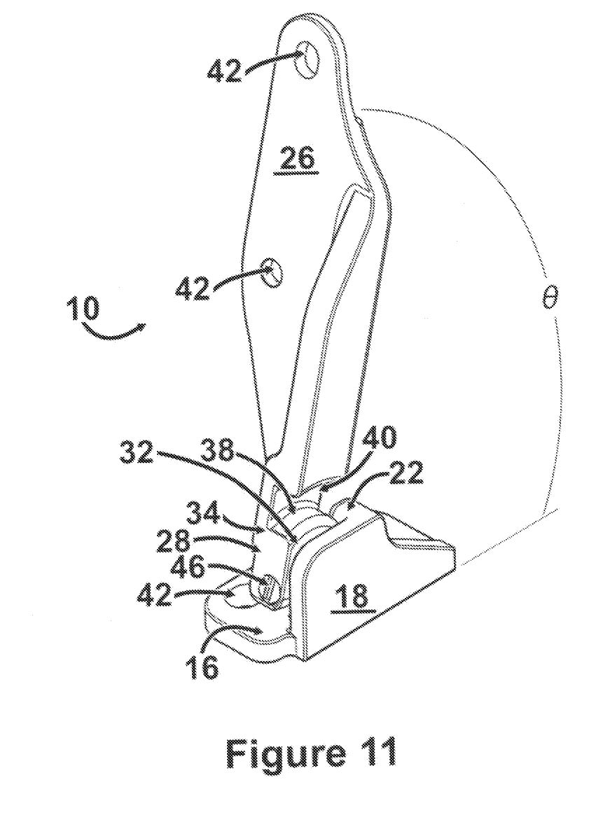

To assemble the first embodiment 10, the second part 14 is oriented relative to the first part 12 so that the cylindrical protuberance 20 receives the extended arms 34 of the u-shaped member 28, as shown in FIG. 8. In that alignment, the arcuate inner member surface 36 of the u-shaped member 28 of the second part 14 is received into the groove 24 of the protuberance. Retaining screw 46 is inserted into tapped hole 44, as shown in FIG. 10, to prevent axial movement of the second part 14 relative to the first part 12. The screw 46 threads into the hole and is tightened. As it rotates within the hole 44, the length of the screw 46 travels across a portion of the groove 24 on the protuberance 20. This locks the embodiment 10 in and prevents any axial travel of the second part 14 relative to the first part 12, as shown in FIG. 11.

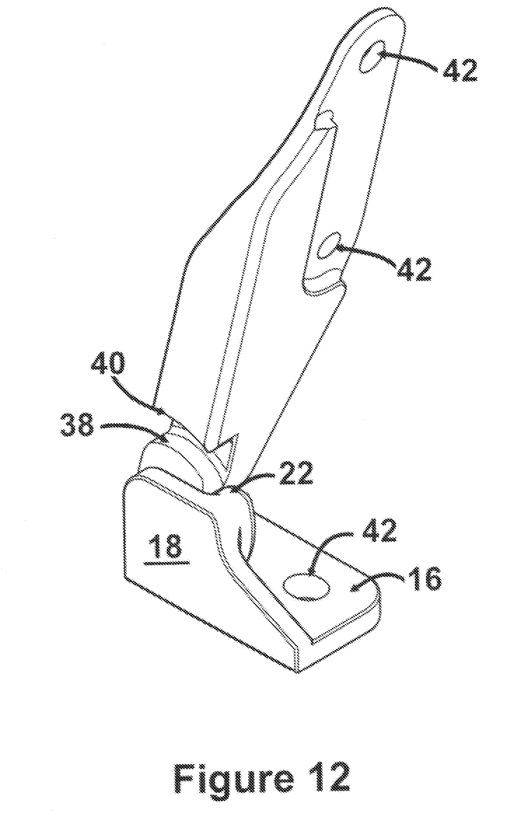

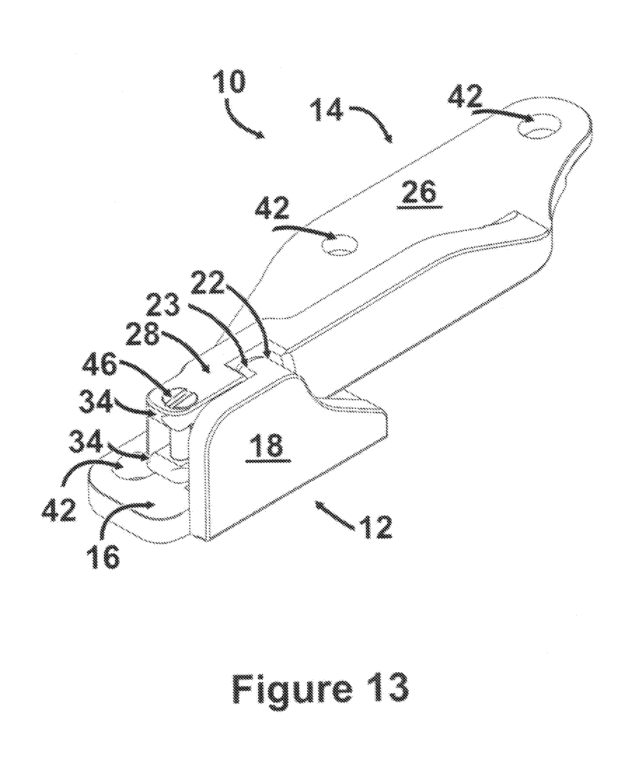

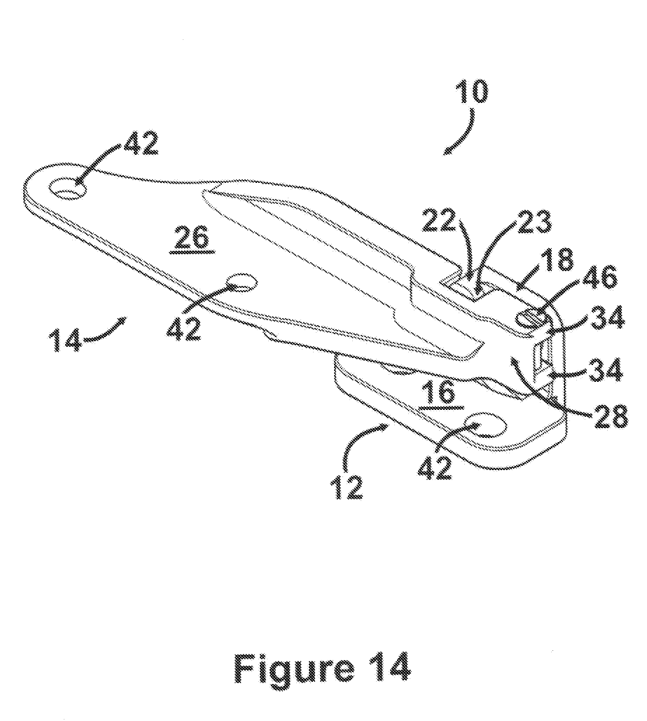

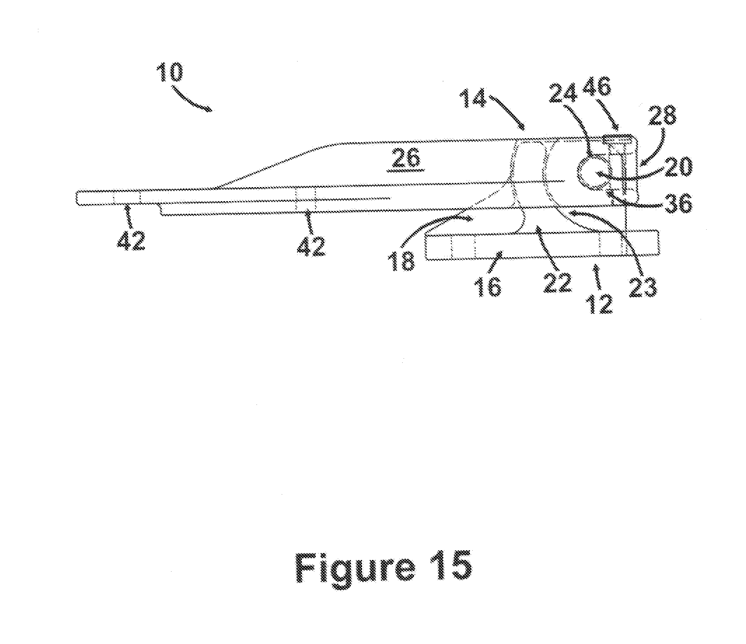

Once the screw 46 secures the second part 14 to the first part 12, the second part 14 may rotate relative to the first part 12, as shown in FIG. 12. As the parts 12, 14 rotate, the arcuate recess 40 is received by the arcuate guide 22. The arcuate recess 40 slides along the arcuate guide 22 as the arcuate member surface 36 slides within the groove 24 of the protuberance 20. Rotational travel of the second part 14 relative to the first part 12 stops when one of the extended arms 34 of the second part 14 abuts the surface of the first plate 16, as shown in FIG. 13.

To disassemble, the process is the same as describe above with regard to assembly but in the reverse order. The first 12 and second parts 14 are rotated away from one another so that they are at an angle θ of 60°, as shown in FIG. 11. The screw 46 is unthreaded and removed from the recess 44. Now the arcuate guide 22 is no longer in contact with the arcuate recess 40, and the extended arms 34 of the u-shaped member are held in position by the protuberance 20 alone. At this time, the second part 14 may be lifted away from the first part as shown in FIG. 8.

The advantage of the releasable hinge assembly is that assembly and disassembly is relatively quick and easy. Once the first part 12 properly engages with the second part 14 as described above, the parts rotate relative to each other about the protuberance 20 as needed. It should be noted that the arcuate guide 22 is shaped to receive the the u-shaped member 28 and arcuate recess 40 when the first 12 and second 14 parts are at a 60° angle relative to one another. This angle θ is referred to herein as the insertion angle. It is anticipated that the insertion angle may be altered to accommodate different applications. In addition, the screw 46 is applied to prevent axial movement of the second part 12. However, it is anticipated that in some applications it may not be needed.

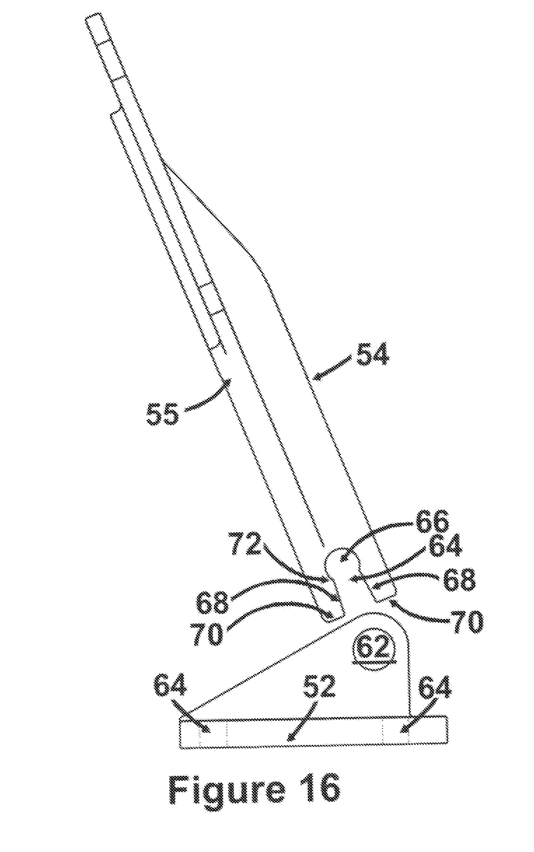

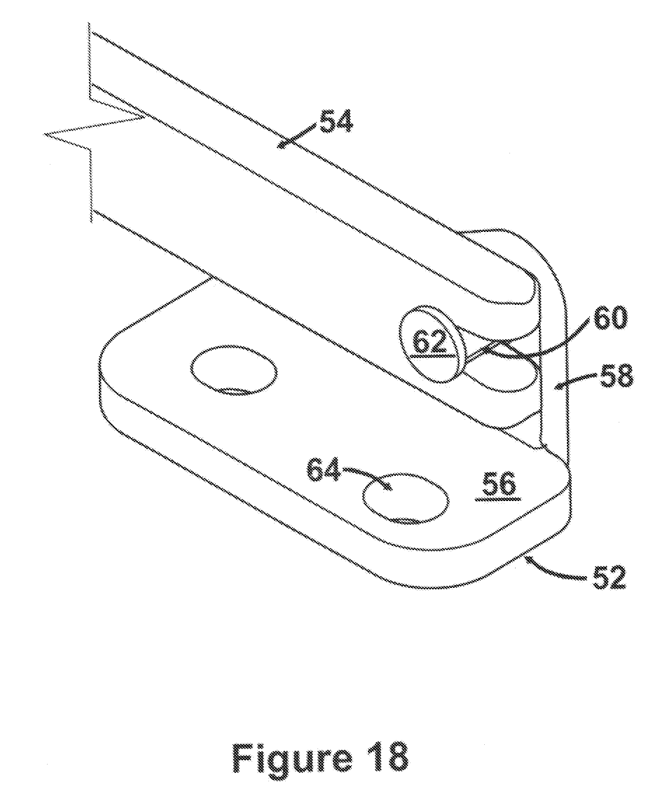

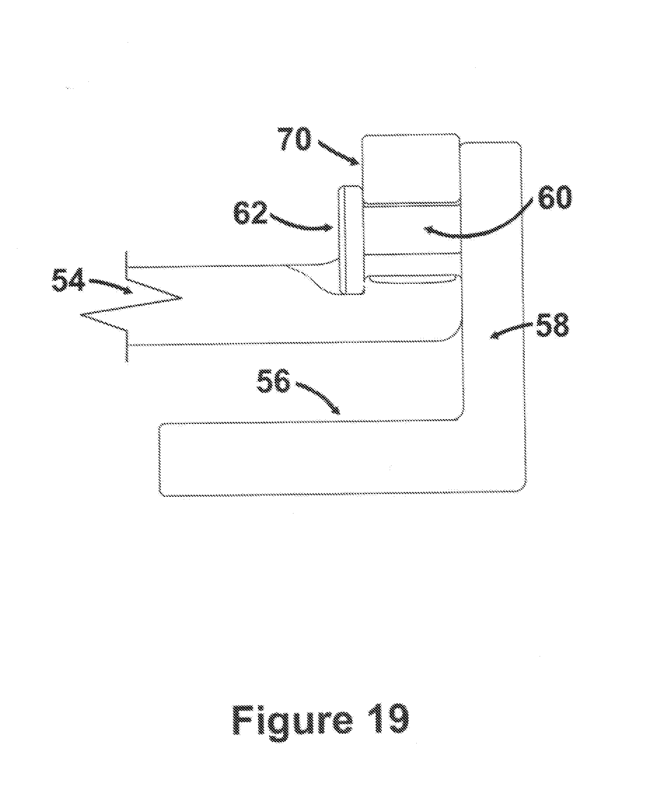

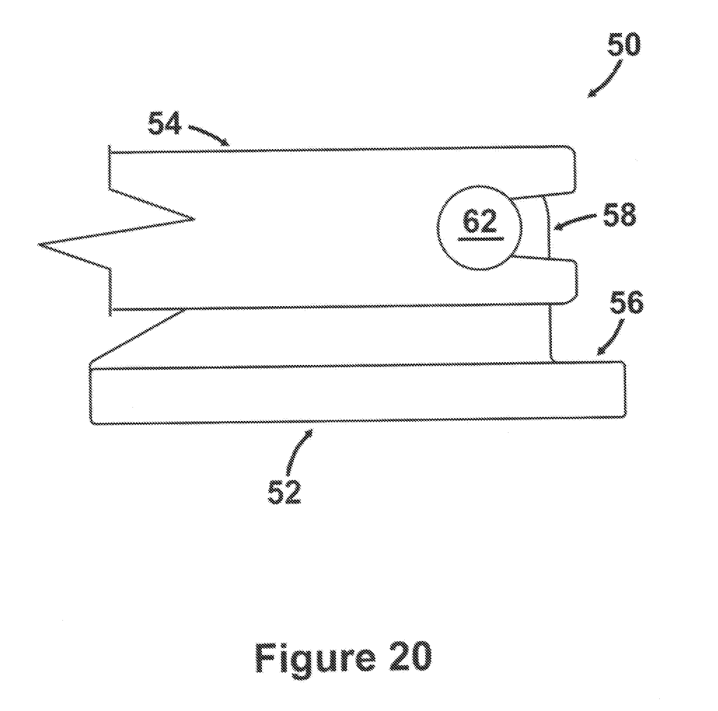

A second embodiment 50 is shown in FIGS. 16 through 20. The second embodiment 50 includes a hinge pin assembly 52 and a u-shaped assembly 54. The hinge pin assembly 52 includes a hinge pin base 56 and a hinge pin member 58 fixed and substantially perpendicular to the base. A cylindrical hinge pin 60, shown in FIG. 18, is fixed and substantially perpendicular to the member 58. The hinge pin 60 has a circular cap 62 located at the opposed end of the hinge pin from the member/hinge pin interface as shown in FIG. 18. The hinge pin base 56 has one or more bolt holes 64 to receive a fastening member (not shown) to secure the hinge pin assembly 52 to a structure.

Turning now to FIG. 16, the u-shaped member 54 includes a slot 64 located at one end of the u-shaped member. The slot 64 has a circular bore portion 66 and a pair of diverging surfaces 68. The slot 64 forms a pair of fingers 70 extending outwardly away from the bore portion 66 of the u-shaped member 54. The intersection of the bore portion 66 and the diverging surface 68 forms a step 72 the function of which will be described in detail below.

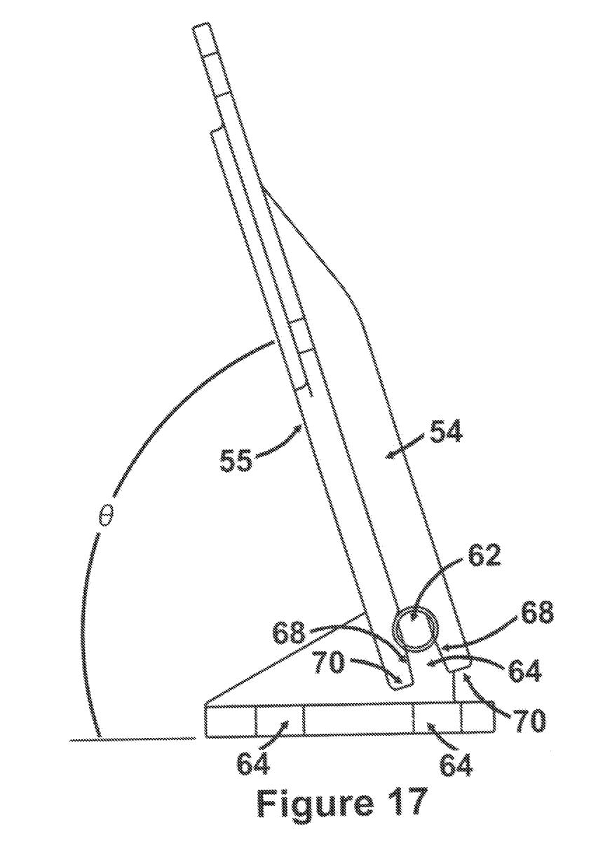

The remaining end of the u-shaped assembly 54 includes an arm 55. The arm 55 may include one or more bolt holes 64 for securing the u-shaped assembly to another structure. To assemble the second embodiment 50, the u-shaped assembly 54 is positioned at an angle above the hinge pin assembly 52. Preferably, this angle θ is about 60° between the axial center of the u-shaped assembly 54 and the hinge pin base 56. The u-shaped assembly 54 is then lowered down toward the hinge pin assembly 52 so that the hinge pin 60 slides between the fingers 70. The second embodiment 50 is completely connected relative to parts 52, 54 when the hinge pin 60 overcomes the step 72 and snaps into the bore portion 66, as shown in FIG. 17. It should be noted that the bore portion 66 and the circumference of the hinge pin 60 are concentric.

Once the u-shaped assembly 54 is assembled relative to the hinge pin assembly 52, the fingers 70 are free to rotate relative to the hinge pin 60. The circular cap 62 prevents the fingers 70 from sliding axially off of the hinge pin 60. The step 72, shown in FIG. 16, prevents the fingers 70 from pulling radially away from engagement with the hinge pin 60.

In use, the u-shaped assembly 54 rotates relative to the hinge pin assembly 52 in a direction towards the hinge pin assembly until the hinge pin base 56 rests against the surface of the arm 55 of the u-shaped assembly 54. It is preferred that the at rest position places the hinge pin base 56 relatively parallel with the arm 55 as shown in FIG. 18. It should be noted that travel of the u-shaped assembly 54 may be stopped by projecting abutments fixed to one or both of the arm 55 and/or the hinge pin base 56.

The embodiments described herein are directed to a releasable hinge assembly. One advantage of the embodiments is the ability to quickly and easily assemble and disassemble the hinge assembly. While applicants have focused above on this advantage as it pertains to auto racing, applicants submit that the same advantages may be realized in home appliances where releasable hinge assemblies may cause fewer hinge failures and thus provide greater consumer satisfaction. Moreover easily removeable hinge assemblies may make it easier for consumers to clean a product, such as an oven or microwave. Other applications of the releasable hinge assembly described in the embodiments herein are too numerous to mention but would include without limitation jewelry, appliances, furniture and the like.

It should be further noted that any abutments or contacting surfaces may have a cushioning material such as a foam to avoid surface to surface contact and to minimize any noise that may occur during vibration of the two adjacent surfaces, especially where the embodiments may apply to machinery or automobiles.

While the embodiments herein have been described in detail above, it is evident that many alternatives, modifications, and variations will be apparent to those skilled in the art in light of the foregoing description. Accordingly, it is intended to embrace all such alternatives, modifications and variations as fall within the spirit and scope of the appended claims.

What is claimed is:

1. A releasable hinge assembly comprising:
a first assembly comprising a cylindrical protuberance fixed to a first hinge element, and an arcuate guide fixed to the hinge element, the guide in spaced apart relation to the protuberance and having an arc concentric to the protuberance;
a second assembly comprises a second hinge element having a u-shaped member extending outwardly therefrom, the u-shaped member having an inner arcuate surface, the second hinge element further comprising an arcuate channel located in spaced apart relation to the inner arcuate surface of the u-shaped member, the inner arcuate surface, channel, and guide being concentric with the protuberance, whereby the u-shaped member of the second assembly receives the protuberance and the channel receives the guide.

2. The hinge assembly of claim 1 wherein the u-shaped member rotates about the protuberance.

3. The hinge assembly of claim 1 wherein the first and second hinge elements are perpendicular to one another.

4. The hinge assembly of claim 1 wherein the u-shaped member receives the protuberance when the first and second hinge elements are at an angle of 60° relative to each other.

5. A releasable hinge comprising:
a first component having a circular hinge pin and an arcuate guide fixed thereto;
a second component having a u-shaped member having an annular groove concentric with and matingly received by the hinge pin, the second component further having an arcuate channel received by the arcuate guide.

6. The hinge of claim 5 wherein the u-shaped member is received by the hinge pin when the first and second components are at a 60° angle relative to each other.

7. The hinge of claim 5 wherein the arcuate channel and arcuate guide are concentric.

8. A method of assembling a hinge comprising the steps of:
providing a first component having a hinge pin and an arcuate guide fixed thereto;
providing a second component having a u-shaped member having an annular groove concentric with the hinge pin, the second component further having an arcuate channel;
orienting the first and second components at an angle of 60° relative to each other;
causing the u-shaped member to receive the hinge pin; and
enabling the second component to rotate within the annular groove about the hinge pin.

9. The method of claim 8 comprising the addition step of enabling the arcuate channel to move relative to the guide.

10. The method of claim 9 wherein the arcuate channel and guide are concentric.

11. A releasable hinge assembly comprising:
a first part having a base and a cylindrical pin extending substantially perpendicular to the base;
a second part having a first end and a second end, the first end having a circular recess with a pair of arms extending therefrom, the arms having divergent surfaces proximate to each other, whereby the cylindrical pin is received into the recess of the second part to form a rotatable hinge assembly.

12. The hinge assembly of claim 11 wherein the intersection of the circular recess and arms forms a step.

13. The hinge assembly of claim 11 further comprising a cap fixed to the end of the cylindrical pin, wherein the outer dimension of the cap is greater than the pin diameter so as to prevent axial movement of the second part.
